(19) United States
(12) Patent Application Publication
(10) Pub. No.: US 2011/0103050 A1
(43) Pub. Date: May 5, 2011

(54) 360 Degree Viewable Light Emitting Apparatus

(76) Inventor: Jeremy Hochman, Austin, TX (US)

(21) Appl. No.: 12/787,172

(22) Filed: May 25, 2010

Related U.S. Application Data
(63) Continuation-in-part of application No. 11/618,387, filed on Dec. 29, 2006, now Pat. No. 7,722,215.
Application No. 11/618,387 is a continuation-in-part of application No. 12/786,203, filed on May 24, 2010, now abandoned.
Application No. 12/786,203 is a continuation of application No. 11/618,387, filed on Dec. 29, 2006, now Pat. No. 7,722,215.
(60) Provisional application No. 60/756,577, filed on Jan. 6, 2006.
(60) Provisional application No. 60/756,577, filed on Jan. 6, 2006.

(51) Int. Cl. F21V 9/00; F21V 21/00; F21S 6/00; F21S 4/00; B29C 39/10

(52) U.S. Cl. 362/231; 362/382; 362/257; 362/249.01; 264/261

(57) ABSTRACT

A light emitting apparatus and method of manufacturing thereof are disclosed. The light emitting apparatus includes a plurality of printed circuit boards connected to one another, a light emitting element disposed on and electrically connected to each printed circuit board, and at least one connector disposed between the printed circuit boards. The method of manufacturing the light emitting apparatus includes disposing a light emitting element on a plurality of printed circuit boards, arranging planar surfaces of the plurality of printed circuit boards substantially opposite, and connecting the plurality of printed circuit boards to one another.

### CROSS-REFERENCE TO RELATED APPLICATIONS

This patent application is a continuation-in-part of U.S. patent application Ser. No. 11/618,387, filed Dec. 29, 2006 and issued as U.S. Pat. No. 7,722,215 on May 25, 2010, which claims the benefit of U.S. provisional application 60/756,577, filed Jan. 6, 2006, and U.S. patent application Ser. No. 12/786,203, filed May 24, 2010. These applications are incorporated by reference along with all other references cited in this application.

### BACKGROUND OF THE INVENTION

1. Field of the Invention

Embodiments disclosed herein generally relate to light emitting apparatuses. Specifically, selected embodiments relate to an improved light emitting apparatus for use in various industries.

2. Background Art

Currently, the market for light emitting diode (LED) technology is growing at an astonishing rate for use in various industries, such as in the entertainment, advertising, and architecture industries. Within this LED technology market are linear LED products, such as LED tubes and LED ropes. These linear LED products have been large contributors to the market's popularity because of their versatility in usage. For example, the linear LED products may be used for neon simulators, decorative lightings, in addition to low resolution video displays.

Because of their high demand, LED ropes and LED tubes are available from several manufacturers. The LED ropes are generally available, though, in a form that is only viewable from one side. The side of the LED ropes that is not viewable contains wires and components that blocks light from the LEDs within the rope from being seen. Similarly, the LED tubes are generally in a form that prevents a 360 degree viewable angle. These LED tubes have an extruded or fabricated metal or plastic component to cover at least a portion of the back of the tubes. This back component of the LED tubes is usually used as a structural support, or a base for the LEDs within the tubes. U.S. Pat. Nos. 6,676,284 and 7,118,248, issued to Willson, and U.S. Pat. No. 6,592,238, issued to Cleaver et al., disclose examples of such LED tube systems with a limited viewable angle.

FIG. 1 shows an example of a LED tube 101 with a linear array of LEDs 105. LED tube 101 includes an elongate diffuser 103, made of rigid, translucent diffusing plastics material, mounted onto a base 109. LEDs 105 are mounted on and electrically connected to a printed circuit board 107 (PCB), in which PCB 107 is mounted on and supported by base 109. Commonly, linear array of LEDs 105 are in close proximity to one another, individually controlled, and have a repeating pattern of colors of red, blue, and green. When in operation and illuminated, light from linear array of LEDs 105 is diffused through diffuser 103 such that, by a distant viewer, the light appears to be emanating from a continuous light source, instead of from individual point light sources of LEDs 105.

FIG. 2 shows another example of a LED tube 201. Similar to LED tube 101 in FIG. 1, LED tube 201 comprises a linear array of LEDs 205 mounted on and electrically connected to a PCB 207, in which PCB 207 is mounted on and supported by a base 209. Additionally, LED tube 201 has two diffusers (an outer diffuser 203 and an inner diffuser 213) and a reflector 211. Reflector 211 may be used to maximize the light output from LEDs 205, such as reducing the light loss to PCB 207.

As shown with FIGS. 1 and 2, the LED tubes make use of PCB-mounted LEDs with the LEDs arranged in an array or line within the tubes. In these arrangements, the viewable angle of light surrounding the LED tubes is limited by the PCBs and bases on which the LEDs are mounted. In FIG. 1, the viewable angle of LED tube 101 is limited to about 190 degrees. In FIG. 2, the viewable angle of LED tube 201 is limited to about 270 degrees. The use of the diffusers may increase the viewable angles of the LED tubes, but a substantial portion of the LED tubes is blocked by internal and external components of the tubes. With these components blocking light emitting from the LED tubes, the viewable angle of the light from the LED tubes is limited.

In response to these common limited viewable angle LED tubes, many manufacturers have created “360 degree” viewable angle linear LED products. These linear LED products, though, still require wires or connectors to pass the data and power signals from one light source to the next. The wires and connectors may then produce a shadow, dark area, or discontinuity on the outside diffuser of the linear LED product. Thus, the viewable angle of linear LED products is still limited from the full 360 degrees.

Accordingly, there exists a need for a linear LED product that minimizes any shadows or discontinuities by the internal connections, wires, or support structures to allow the LED product to be fully viewable from all 360 degrees surrounding the product.

### BRIEF SUMMARY OF THE INVENTION

In one aspect, embodiments disclosed herein relate to a light emitting apparatus. The light emitting apparatus includes a plurality of printed circuit boards electrically connected to one another, a light emitting element disposed on and electrically connected to each of the plurality of printed circuit boards, and at least one connector disposed between the plurality of printed circuit boards.

In another aspect, embodiments disclosed herein relate to another light emitting apparatus. The light emitting apparatus includes a first printed circuit board having a planar surface, a second printed circuit board having a planar surface, at least one light emitting element disposed on the first and second printed circuit boards, and at least one connector disposed between the first and second printed circuit boards. The planar surface of the second printed circuit board is arranged substantially opposite to the planar surface of the first printed circuit board, and the first printed circuit board is electrically connected to the second printed circuit board.

Further, in another aspect, embodiments disclosed herein relate to a method for manufacturing a light emitting apparatus. The method includes disposing a light emitting element on a plurality of printed circuit boards, arranging the plurality of printed circuit boards such that planar surfaces of the plurality of printed circuit boards are substantially opposite, and electrically connecting the plurality of printed circuit boards to one another.

In an implementation, a device includes: a first printed circuit board, where the first printed circuit board has a first edge; a second printed circuit board; at least a first connector, connecting to and extending between the first and second printed circuit boards; and a light emitting element positioned on the first printed circuit board and electrically connected to the first printed circuit board, where a shortest distance between the first connector to the first edge is less than a shortest distance between the light emitting element to the edge.

The first and second printed circuit boards may be arranged in a column. The second printed circuit board is above the light emitting element and the first printed circuit board, and the first connector extends generally transverse or perpendicular to surfaces of the first and second printed circuit boards.

The device may include a wire, extending between the first and second printed circuit boards and connected to electrical traces of the first and second printed circuit boards. The wire may connect to electrical traces of the first and second printed circuit boards and is routed between the first and second printed circuit boards adjacent to (e.g., attached, glued, or clipped to) the first connector.

The first connector may include an electrically conductive portion that facilitates an electrical connection between electrical traces of the first and second printed circuit boards. Additionally to the electrically conductive portion, the first connector may include a support portion that can be rigid. The first connector can include at least a rigid nonelectrically conductive portion that does not pass electricity between the first and second printed circuit boards. This support portion can be not electrically conductive, such as made from an insulating material like plastic, glass, or wood. Or the support portion may be metal, but not used to conduct electricity, while a wire with insulation is used instead.

Further, the device can optionally include an audio output element (e.g., speaker) positioned on the first printed circuit board and electrically connected to the first printed circuit board. The device can include an optical diffuser material substantially encompassing (or surrounding) the first printed circuit board with the light emitting element and second printed circuit board. The device can optionally include an audio input element (e.g., a microphone).

When a surrounding optical diffuser (e.g., cylindrical plastic or glass) is used, the optical diffuser material has a circular cross section (e.g., correspondingly the PCB will have a single edge). The optical diffuser material may be faceted on the inside or outside, or both, of the material to further diffuse the light. The optical diffuser material can a polygonal cross section, such a three or more sides. The optical diffuser material can have an oval cross section. The optical diffuser material can have a rectangular or square cross section (e.g., correspondingly the PCB will have four edges).

The device can include an optically diffusing gel material encapsulating the first printed circuit board with the light emitting element and second printed circuit board, where the at least a first connector is flexible. The optically diffusing gel material can have a circular cross section. The optically diffusing gel material can have a polygonal cross section. The optically diffusing gel material can have an oval cross section. The optically diffusing gel material can have a rectangular or square cross section (e.g., correspondingly the PCB will have four edges).

The optically diffusing gel material may be a flexible polymer material, which may include silicone. The optically diffusing gel material can fill a space between the first and second printed circuit boards. Further, the optically diffusing gel material can be a foam, which includes bubbles in the gel material. The optical diffuser material may be a rigid polymer. The optical diffuser material may be a flexible polymer, which can be flexed and then returned to its original shape. The optical diffuser material (gel or solid) may include silicon dioxide, quartz, or glass, that may be coated with a phosphor material that exhibits phosphorescence.

The first connector can be a wire. The light emitting element can include a first light emitting diode emitting light of a first color and a second light emitting diode emitting light of a second color.

In an implementation, a device includes: a first printed circuit board, where the first printed circuit board has a first edge; a second printed circuit board; at least a first connector, connecting to and extending between the first and second printed circuit boards; and a first light emitting element connected to and positioned on the first connector, where the first and second printed circuit board are arranged in a column, and the light emitting element is between the first and second printed circuit boards.

A second light emitting element may be positioned on the first printed circuit board and electrically connected to the first printed circuit board, where a shortest distance between the first connector to the first edge is less than a shortest distance between the first light emitting element to the edge. The device may further (optionally) include an audio output element positioned on the first printed circuit board and electrically connected to the first printed circuit board.

In an implementation, A method of making a light emitting apparatus includes: providing a first module, the first module comprising a first light emitting element, a first PCB, and at least a first connector; providing a mold to shape the light emitting apparatus; inserting the first module into the mold; and after inserting the first module into the mold, inserting a diffusion material into the mold, the diffusion material being arranged to come into contact with the first module.

The method can include removing the mold after a first time period. The diffusion material may include a silicone material or other polymer material, which can be a foam. The diffusion material can substantially fill the mold. Further method includes providing a second module, the second module comprising a second light emitting element, a second PCB, and at least a second connector; inserting the second module into the mold; and after inserting the second module into the mold, inserting a diffusion material into the mold, the diffusion material being arranged to come into contact with the second module.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a cross-sectional view of a prior art LED tube.

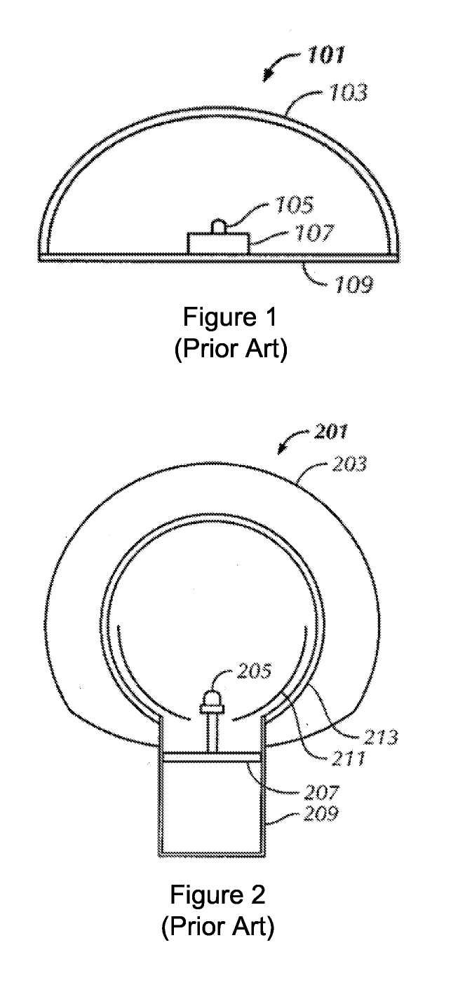

FIG. 2 shows a cross-sectional view of another prior art LED tube.

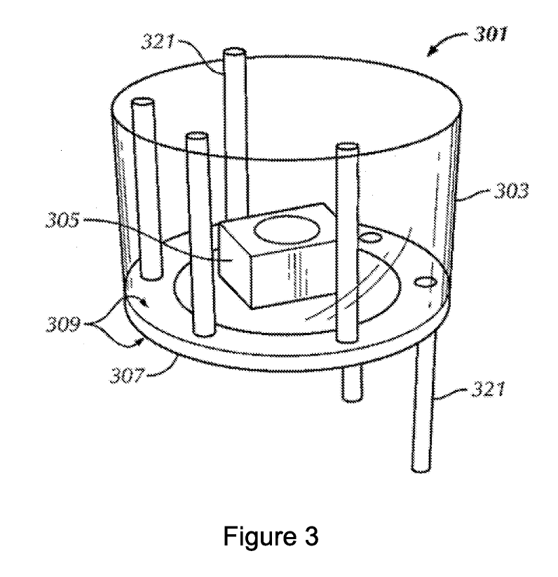

FIG. 3 shows a perspective view of a module of a light emitting apparatus in accordance with embodiments disclosed herein.

FIGS. 4A-4C show perspective views of a module of a light emitting apparatus in accordance with embodiments disclosed herein.

FIG. 5 shows a perspective view of a light emitting apparatus in accordance with embodiments disclosed herein.

FIGS. 6A-6D shows perspective views of a light emitting apparatus in accordance with embodiments disclosed herein.

FIG. 7A shows a specific implementation of a light emitting element of a module disposed on a connector in accordance with embodiments disclosed herein. FIG. 7B shows a specific implementation of a light emitting element of a light emitting apparatus disposed on an edge of a PCB in accordance with embodiments disclosed herein. FIG. 7C shows a specific implementation of a light emitting element of a light emitting apparatus disposed on an optical material in accordance with embodiments disclosed herein.

FIGS. 8A-8B show specific implementations of a module having two light emitting elements in accordance with embodiments disclosed herein.

FIG. 9 shows a perspective view of a module having an audio output device disposed on a light emitting element in accordance with embodiments disclosed herein.

FIGS. 10-13 show a perspective view of a module having an audio output device disposed on or connected to a PCB in accordance with embodiments disclosed herein.

FIG. 14 shows a perspective view of a module having an audio output device disposed on a connector in accordance with embodiments disclosed herein.

FIG. 15 shows a perspective view of a module having two audio output devices in accordance with embodiments disclosed herein.

FIG. 16A shows an embodiment of a module having four light emitting diodes. FIG. 16B shows a specific embodiment of an audio output device arranged above a light emitting element and disposed on a support.

FIGS. 17A-B shows a perspective view of an apparatus having an audio output device in accordance with embodiments disclosed herein.

FIGS. 18A-18B show perspective views of a light emitting apparatus in accordance with embodiments disclosed herein.

FIGS. 19-24 show steps in a process for using a gel material and a mold to diffuse light for a light emitting apparatus.

FIG. 25 shows another specific implementation of a light emitting apparatus substantially enclosed by a mold.

FIG. 26 shows a light emitting apparatus having a light emitting element 2605a disposed PCB, where the apparatus is flexed into a different positioning from initial state.

### DETAILED DESCRIPTION OF THE INVENTION

In one aspect, embodiments disclosed herein relate to an improved light emitting apparatus with a 360 degree viewable angle. In another aspect, embodiments disclosed herein relate to a light emitting apparatus having a plurality of printed circuit boards (PCBs), in which a light emitting element is disposed on each of the plurality of PCBs. In another aspect, embodiments disclosed herein relate to a light emitting apparatus having a plurality of PCBs, in which planar surfaces of the PCBs are substantially opposite of one another.

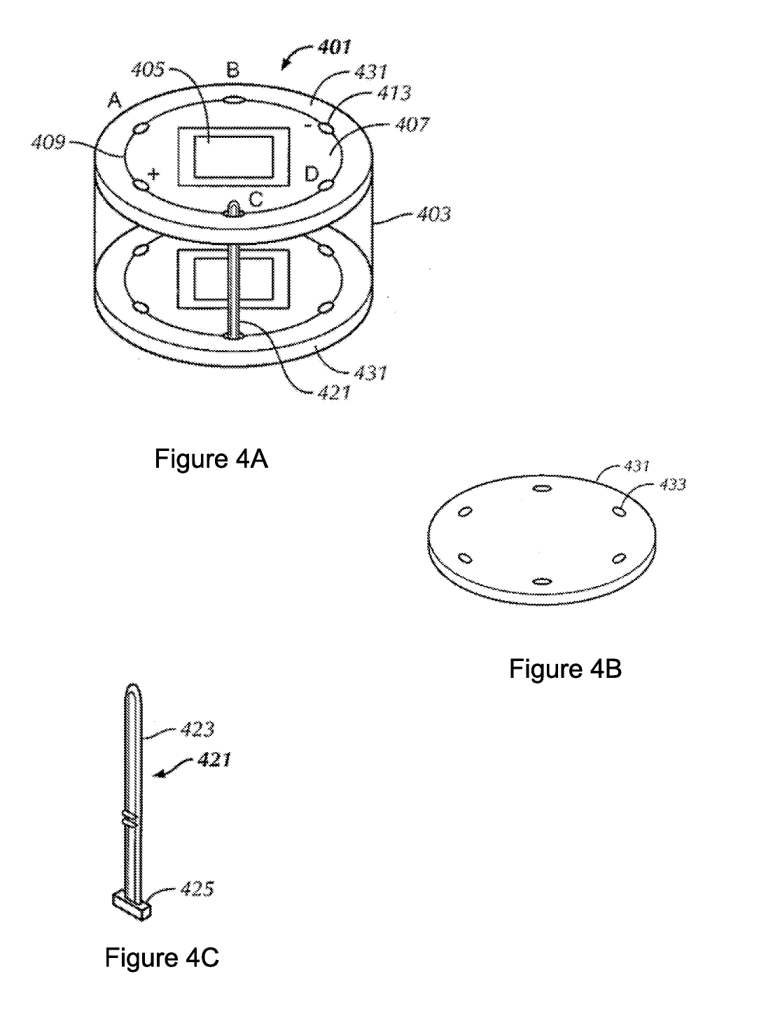

FIG. 3 shows a perspective view of a module 301 of a light emitting apparatus in accordance with embodiments disclosed herein. Module 301 includes a light emitting element 305 disposed on a PCB 307. As shown, PCB 307 may include planar surfaces 309 (e.g., planar surfaces 309 may include a top surface and a bottom surface or a first and a second surface of PCB 307). The PCB can have any shape, polygonal, circular, oval, or other. Typically a PCB has two planar exposed surfaces. However, a PCB can have any number of electrical layers for connecting electronic components. For example, a PCB may be two layers (e.g., exposed top and bottom layers) or three, four, five, six, or more layers. Typically, the PCB will have a similar shape as a cross-sectional shape of the 360-degree viewable light emitting apparatus the PCB is used to implement. For example, when the light emitting apparatus is circular, the PCB is circular. When the light emitting apparatus is rectangular, the PCB is rectangular or square. However, the light emitting apparatus may have a different cross-sectional shape the PCB which is enclosed by the light emitting apparatus. For example, when the light emitting apparatus is rectangular or square, the PCB may be circular or other shape that fits within the rectangular or square apparatus.

Light emitting element 305 may be disposed on one of, or both, planar surfaces 309. Light emitting element 305 is electrically connected to PCB 307 to enable signals from PCB 307 to control (e.g., turn on and off) light emitting element 305. Typically, the light emitting element is soldered on the PCB and connected to electrical traces or wires of the PCB. Electrical power and other electrical signals can be transmitted to the light emitting element via the electrical traces or wires. These electrical traces can carry power (e.g., VDD and ground) or control signals (e.g., Boolean or logical signals), or both.

The light emitting element may be a single LED or multiple LEDs, each being of the same or different color. Multiple LEDs of the same color may be used to increase the brightness, and also allowing dimming of the lighting. For example, there may be five LEDs of the same color. Five LEDs on will be give brightest light. Four LEDs on give less lighting than five. One LED gives the dimmest light. And zero LEDs will give no light. The dimming or other lighting control can be controlled via the electrical traces or wires (supply power or control signals, or both) to the light emitting element.

An optical material or optical diffuser material 303 may then encompass, substantially encompass, or enclose PCB 307 and light emitting element 305 of module 301. In this embodiment, optical material 303 is supported against outer edges of PCB 307 to encompass module 301. Further, connectors 321 are disposed on and electrically connected to PCB 307. Connectors 321 may carry all necessary data and power signals for controlling module 301, in which the data and power signals may be supplied to light emitting element 305 through PCB 307. As shown, connectors 321 may be circular in cross section with a minimum-sized diameter to impede as little amount of light as possible emitting from light emitting element 305 and reaching optical material 303.

The light emitting element can include light emitting diodes emitting light of various combinations of colors. For example, in one embodiment, a light emitting element has a first light emitting diode (LED) emitting light of a first color and a second light emitting diode (LED) emitting light of a second color. The first color and the second color can be the same color, different hues of the same color, or different colors, depending on the desired color display of the user. LEDs are a type of lighting technology that are used in a specific implementation of the invention. However, LEDs are merely one example of a lighting technology that the invention may utilize. Other light technologies may be used including incandescent light bulbs (e.g., tungsten, sodium vapor), black or ultraviolet color or wavelength lighting (e.g., for special effects using fluorescent or luminescent material, or tanning), infrared color or wavelength lighting (e.g., heating or curing), fluorescent bulb technology, organic LED technology, plasma technology, and many others.

In an implementation, the optical material comprises a diffusive material to diffuse light emitted from light emitting element. However, those having ordinary skill in the art will appreciate that the invention is not so limited, and the optical material may comprise a transparent material, a translucent material, a colored material, a refractive material, a reflective material, a catadioptric material; in addition to any other materials. Further, those having ordinary skill in the art will appreciate that the invention is not limited to any particular shape. Thus, the optical material may comprise a spherical shape, an aspherical shape, a convex shape, a concave shape, a conical shape, an elliptical shape, a hyperbolic shape, a parabolic shape, a lenticular shape, in addition to any other shapes. Furthermore, the optical material may comprise any combination of the previously suggested materials and shapes. For example, the optical material may comprise a conical shape with one portion a diffusive material and another portion a colored material, or the optical material may comprise a portion that is both a diffusive and colored material that is of a spherical shape. Moreover, the optical material may be circular in cross section. In other embodiments, the optical material may have a triangular, square, rectangular, or oval cross section, in addition to many other polygonal and nonpolygonal cross sections.

Using the connectors to connect between multiple PCBs, multiple modules may be arranged in a stack or “column alignment” to assemble a light emitting apparatus of the present invention. As used herein, a column alignment refers to an arrangement of the PCBs with respect to one another, in which the PCBs are positioned one above the other with the connectors disposed between the PCBs. Thus, the light emitting apparatus of the present invention may comprise an arrangement of alternating PCBs and connectors with an optical material encompassing or encapsulating the PCBs.

Those having ordinary skill in the art will appreciate that, although embodiments disclosed herein are only shown with one light emitting element disposed on and electrically connected to each PCB, the invention is not so limited. In other embodiments, multiple light emitting elements, such as multiple LEDs, may be disposed on each PCB. In such a case, the LEDs may emit different colors or wavelengths, such as red, green, and blue, as is common for a pixel comprised of LEDs. Other colors include cyan, yellow, violet, purple, pink, white, and magenta.

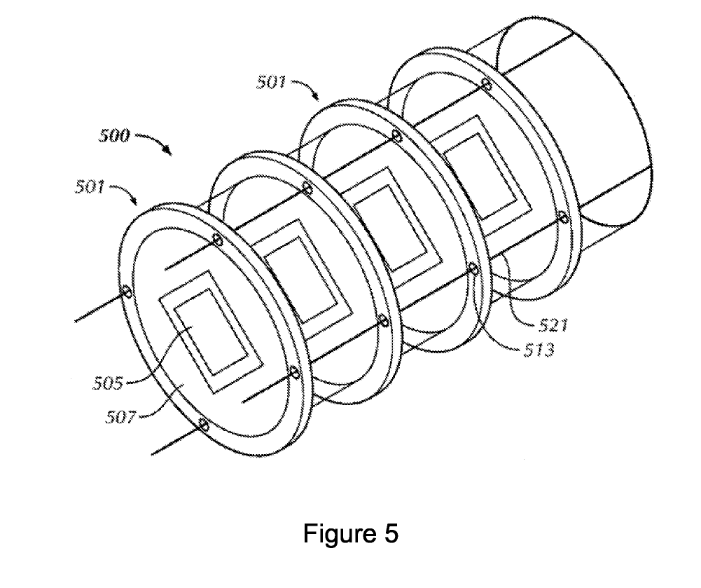

FIGS. 4A-4C show a perspective view of a module 401 of a light emitting apparatus in accordance with embodiments disclosed herein. Module 401 in FIG. 4A includes a light emitting element 405 disposed on and electrically connected to PCB 407 with an optical material 403 encompassing or enclosing PCB 407 and light emitting element 405. As shown in the figure, the optical material substantially encompasses a first printed circuit board with the light emitting element and also a second printed circuit board. In this embodiment, PCB 407 is disposed on a support structure 431 (shown in FIG. 4B), which may be comprised of the same or similar material as optical material 403. Support structure 431 includes guide holes 433 to correspond with guide holes 413 of PCB 407. Specifically, guide holes 433 of support structure 431 are approximately in the same location corresponding to guide holes 413 of PCB 407 so that when PCB 407 is disposed on support structure 431, connectors 421 (shown in FIG. 4C) may pass through holes 413 and 433 without any intrusions.

As shown in FIG. 4C, connector 421 may be a thin, flat blade or fastener and include a pin section 423 and a crimp section 425. Preferably, pin section 423 is sufficient in width to provide a current flow for the transmission of the necessary data and power signals for multiple modules 401, but remains relatively thin to impede a minimum amount of light emitting from light emitting element 405 reaching optical material 403. Crimp section 425 may be used to retain connector 421 within hole 433 of support structure 431 and pin section 423 may be used to electrically connect multiple PCBs 407 to one another. When connected to PCBs 407, preferably connectors 421 are oriented within holes 413, 433 such that pin sections 423 are aligned parallel with the light rays emitting from light emitting elements 405 to impede as little amount of light as possible emitting from light emitting elements 405 reaching optical material 403.

Referring back to FIG. 4A, module 401 may include as many as six holes 413, 433 within PCB 407 and support structure 431, if not more. With six locations (e.g., A, B, C, D, +, −) of holes 413, 433, locations + and − may be used for transmission of power signals, and locations A, B, C, and D may be used for transmission of data or control signals (e.g., Boolean signals). For example, when connecting two modules 401, one module may use locations A, B, +, and − of holes 413, 433 for transmission data and power signals, and the other module may use locations C, D, +, and − of holes 413, 433 for transmission of data and power signals. Therefore, some of the data and power signals supplied by connectors 421 through holes 413, 433 may not be utilized in one module, but may be used in another module. However, one having ordinary skill in the art will appreciate the invention is not so limited, and any number of the holes within the PCB may be used.

As shown, the connectors disposed between the multiple PCBs and the optical material that encompasses the PCBs may comprise a rigid material to provide structural support for the light emitting apparatus of the present invention. However, those having ordinary skill in the art will appreciate that the invention is not so limited. For example, in another embodiment, the connectors disposed between the PCBs may comprise a flexible material (e.g., metal bellows) or a spring material (e.g., rubber or metal springs) and the optical material may comprise a flexible material (e.g., thin plastic). In such an embodiment, the light emitting apparatus may then be bent in any direction, similar to that of rope, to increase the flexibility and versatility of the present invention.

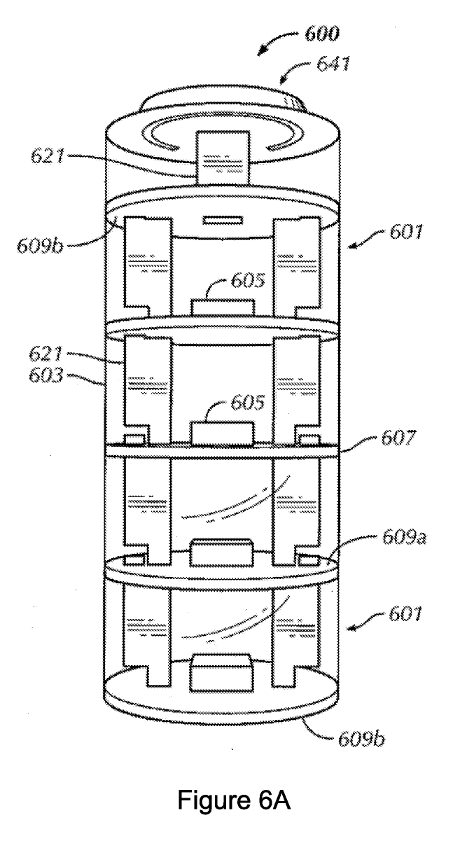

FIG. 5 shows a perspective view of multiple modules 501 of a light emitting apparatus 500 in accordance with embodiments disclosed herein. Similar to modules 301, 401 described above, modules 501 include light emitting elements 505 disposed on and electrically connected to PCBs 507. Further, in this embodiment, PCBs 507 include holes 513 for connectors 521 to pass through PCBs 507.

In FIG. 5, connectors 521 are between the PCBs. In an implementation, connectors 521 are used as a support structure for the PCBs. Electrical connections can be passed by one or more wires running along the structure.

An electrical connection between two or more points on a PCB can be made using an electrical trace or track. A trace is a strip of metal or a wire that carries signals or current between these points on a PCB. The traces can be made of gold, copper, aluminum, tin, iron, or other metals. In an implementation, a wire extends between a first PCB and a second PCB and is connected to or coupled to electrical traces of the first and second PCBs. The placement or positioning of the wires may vary. For example, a wire, connected to or coupled to electrical traces of a first PCB and a second PCB, can be routed between the first and second PCBs adjacent to a connector.

The connector between the PCBs can support the PCBs, electrically connect the PCBs by providing electrical connections, or both. In an implementation, this connector has an electrically conductive portion that facilitates an electrical connection between electrical traces of the first and second PCBs. In another implementation, the connector has a rigid nonelectrically conductive portion that does not pass electricity between the first and second printed circuit boards. In this implementation, the PCBs may be electrically connected through other means, such as through wires or cables.

As shown, connectors 521 disposed between PCBs 507 may include cables or wires. In such an embodiment, insulation of the cables or wires may be pierced at the location of the holes to provide an electrical connection with the PCBs. Alternatively, instead of piercing the cables or wires, the cables or wires may be cut and electrically connected to other locations of the PCBs. Alternatively still, the cables or wires may be clamped or secured by connectors disposed on the PCBs to provide an electrical connection with the PCBs.

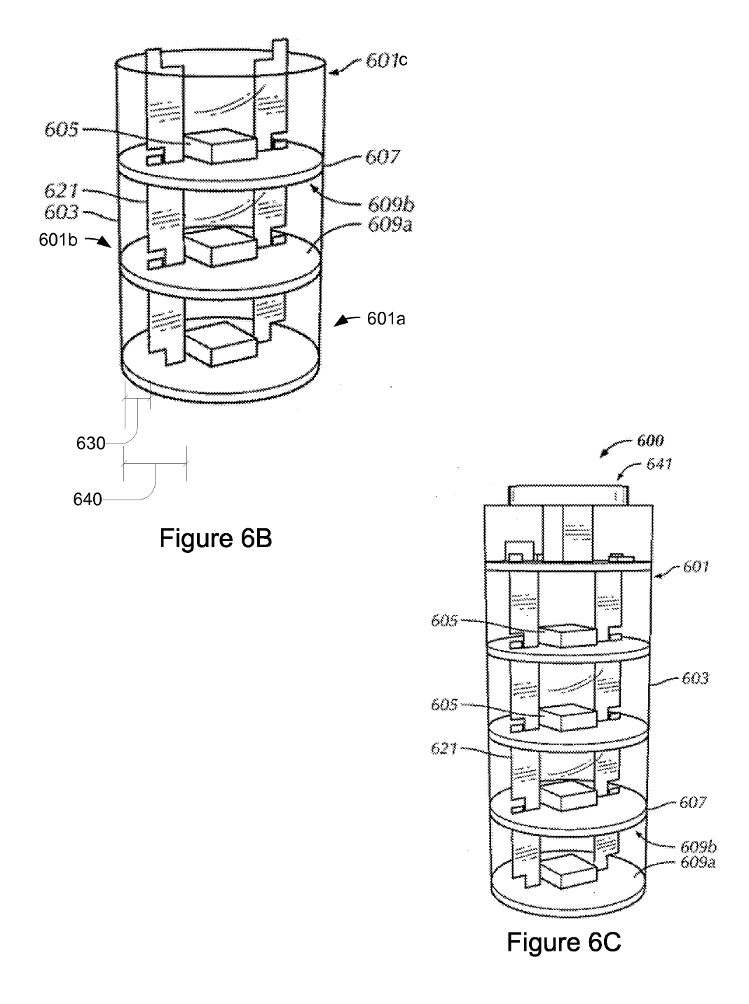

FIGS. 6A-6D show perspective views of multiple modules 601 of a light emitting apparatus 600 in accordance with embodiments disclosed herein. Light emitting elements 605 are disposed on planar surfaces 609 of PCBs 607 and electrically connected to PCBs 607 with an optical material 603 encompassing PCBs 607 and light emitting elements 605. Connectors 621 are disposed between and electrically connected to PCBs 607. Data and power signals to control light emitting elements 605 may be sent from a source (not shown) through an end 641 of light emitting apparatus 600 into each module 601 and PCB 607 using connectors 621. Thus, in this embodiment, the data and power signals for all the modules of the light emitting apparatus may be sent through the connectors into each module. As such, the modules may only use the data and power signals attributed to their particular module when controlled.

Alternatively, instead of only sending the data and power signals from one or more of the ends of the light emitting apparatus to the modules, those having ordinary skill in the art will appreciate that the modules of the light emitting apparatus may include electrical connections to receive power and data signals from one or more sources. For example, a module of the light emitting apparatus may include an electrical connection within the optical material and the PCB to allow for power and data signals from additional sources to be supplied to specific modules of the light emitting apparatus. As such, this may enable longer and/or larger light emitting apparatuses to be created because multiple electrical connections may be used to supply data and power signals to the light emitting apparatus.

Further, the modules of the light emitting apparatus may be manufactured separately such that each module may be independently connected and disconnected to the light emitting apparatus. In such an embodiment, the light emitting apparatus may be modular to enable quick and easy construction of the light emitting apparatus with the separately manufactured modules. In this embodiment, the placement of components in one module may be different from the placement of components in another module. For example, a first module may have a light emitting element disposed on the middle of a PCB, and a second module may have a light emitting element disposed on a left side of a PCB. These two modules may be connected to each other and the light emitting elements may receive data and power signals from a same source or different source.

In the embodiments disclosed herein, the light emitting apparatus of the present invention includes multiple PCBs. These PCBs are arranged within the light emitting apparatus such that the planar surfaces of PCBs are “substantially opposite” of one another. As used herein, substantially opposite refers to the arrangement of the PCBs with respect to one another, in which the PCBs are arranged within the light emitting apparatus such that planar surfaces of the PCBs substantially face one another. Thus, when the planar surfaces of PCBs are substantially opposite, light emitting from a light emitting element disposed on one planar surface of a PCB may emit light onto another planar surface of a PCB. For example, in FIG. 6A, PCBs 607 have two planar surfaces, a first planar surface 609A and a second planar surface 609B. The planar surfaces 609A of PCBs 607 with light emitting elements 605 are directly opposite, parallel to, and facing planar surfaces 609B of PCBs 607 without light emitting elements 605. When light emitting elements 605 are disposed on planar surfaces 609A, a shortest distance from planar surface 609A of a first module to planar surface 609B of a second module is less than a shortest distance from planar surface 609A of a first module to planar surface 609A of the second module.

Light emitting elements 605 are shown as being disposed on planar surfaces 609A. However, one having ordinary skill in the art will appreciate that light emitting elements 605 can be positioned at or disposed on different locations of the module. For example, in an implementation, light emitting elements 605 are disposed on planar surfaces 609B. In another implementation, in a first module, a light emitting element 605 is disposed on planar surface 609A, and in a second module, a light emitting element 605 is disposed on planar surface 609B, and these two modules are connected and receive data from a same source or a different source.

However, in another embodiment, when the planar surfaces of the PCBs are substantially opposite to one another, the orientation angles of the PCBs may be such that the planar surfaces of the PCBs are not parallel to one another. In such an embodiment, one planar surface of a PCB may be oriented 45 degrees in one direction, while a planar surface of the next PCB may be oriented 45 degrees in the other direction. Those having ordinary skill in the art will appreciate that other orientations and arrangements with PCBs substantially opposite of one another also exist and are included within the scope of the present invention.

FIG. 6B shows three modules 601a, 601b, and 601c in a column alignment. Each module has a PCB with planar surfaces 609a and 609b, a light emitting element, and at least one connector. Module 601b is positioned below module 601c, and module 601a is positioned below modules 601b and 601c. Accordingly the PCB of module 601b is positioned below the PCB of module 601c, and the PCB of module 601a is positioned below the PCBs of modules 601b and 601c. The PCBs of the modules 601a-601c are arranged in a column. The PCB of module 601b is above the light emitting element and the PCB of module 601a.

A connector 621 extends traverse to surfaces of the PCB of module 601a and the PCB of module 601b. The angle that the connector traverses the surfaces may vary. For example, the connector can extend in a 45 degree angle from the PCB of module 601a to the PCB of module 601b. Further, the connectors of a module may traverse the PCBs at different angles relative to each other. For example, in an implementation of a module, a first connector extends from a surface of a PCB at a 45 degree angle and a second connector extends from the surface of the PCB at a 135 degree angle.

The connector connects to or couples to and extends between the PCB of module 601a and the PCB of module 601b. In this implementation, a length of connectors 621 of module 601a is disposed on planar surface 609a of module 601a and extends from planar surface 609a of module 601a through both planar surfaces 609a and 609b of module 601b. The length of this connector is longer than a length from a planar surface 609a of module 601a to planar surface 609a of module 601b. PCB 607 of module 601b has guide holes to allow connectors 621 of module 601a to pass through the guide holes easily.

Light emitting elements 605 are positioned on a PCB and electrically connected or coupled to the PCB. In particular, a light emitting element is positioned on the PCB of module 601a and is electrically connected to or coupled to the PCB, a light emitting element is positioned on the PCB of module 601b and is electrically connected to or coupled to the PCB, and a light emitting element is positioned on the PCB of module 601c and is electrically connected to or coupled to the PCB.

In module 601a, between the connector to the first edge of the PCB is a distance 630, and between the light emitting element to the first edge of the PCB is a distance 640. Distance 630 is a shortest distance between the connector to the first edge of the PCB, and distance 640 is a shortest distance between the light emitting element to the first edge of the PCB. Distance 630 is less than distance 640.

This figure shows three modules, but other embodiments may have less than three or more than three modules. For example, an embodiment of the invention may have 1, 2, 4, 5, 6, 7, 8, 9, or more modules depending on the lighting display desired by a user.

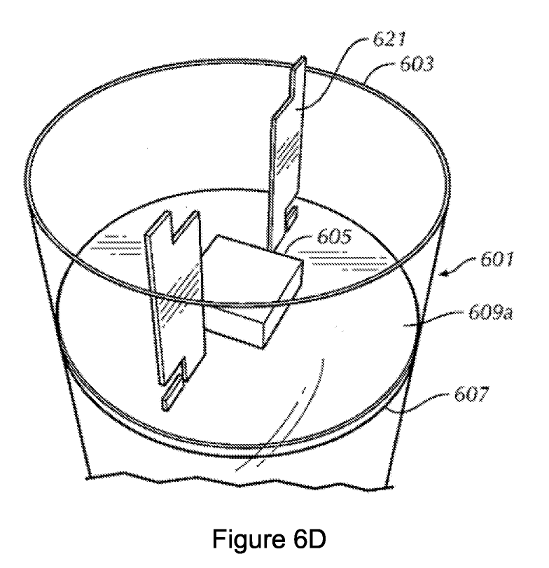

Further, the light emitting element has been described as being disposed on the PCB. However, one having ordinary skill in the art will appreciate the invention is not so limited, and the light emitting element can be disposed on a different surface from the planar surfaces and can also be attached to or disposed on different components within the module. FIG. 7A shows a module 701 having a light emitting element 705, a PCB 707 having a surface 709, and connectors 721a and 721b. The connectors can be connected to or coupled to and extend between a first PCB and a second PCB (not shown). The first and second PCBs can be arranged in a column, and between the first and second PCBs is a light emitting element (not shown in FIG. 7A).

The light emitting element is connected to or coupled to and positioned on connector 721a. The light emitted from the light emitting element may illuminate one side of the module more than another side of the module. To prevent such a problem, an optical device may be included within the module of the light emitting apparatus to recreate a uniform distribution of light within the module.

The light emitting element can also be located at different positions of the module. For example, FIG. 7B shows light emitting element 705 disposed on an outer rim or edge of PCB 707. FIG. 7C shows light emitting element 705 disposed on the optical material. The light emitting element is electrically connected to the PCB (not shown), and the connectors may carry data and power signals, which are supplied to the light emitting element through PCB.

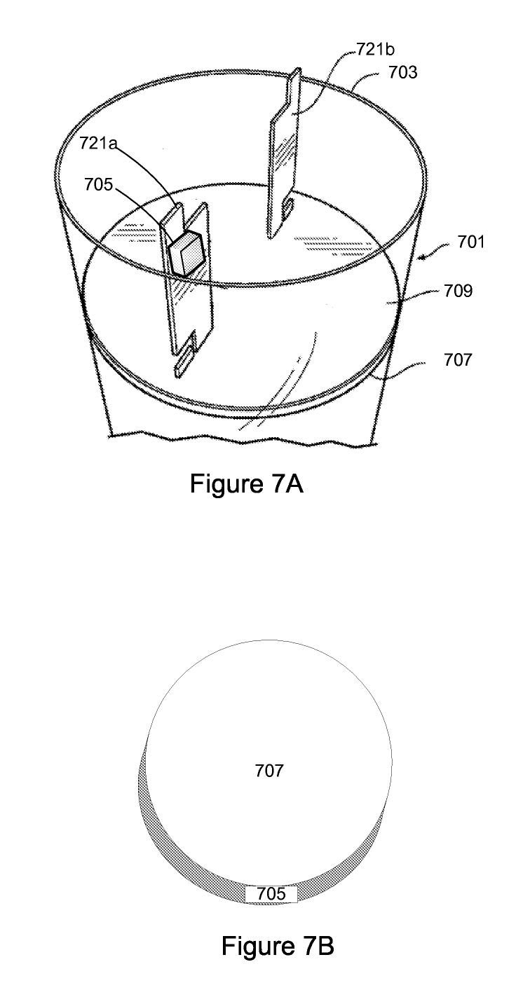

Further, modules can also have more than one light emitting element. FIG. 8A shows a module 801 having two light emitting elements 805a and 805b positioned on a PCB 807 having a first edge. The light emitting elements may be electrically connected to or coupled to the PCB. A shortest distance between a connector 821a to a first edge of the PCB is less than a shortest distance between light emitting element 805a to the first edge of the PCB. The light emitting element may be in physical contact with the connector. In this implementation, the connector may be electrically connected to or coupled to the light emitting element. Alternatively, the light emitting element may not be in physical contact with the connector. In this implementation, the light emitting element may be electrically connected to or coupled to PCB and receive signals and data from the PCB, and not from the connector.

FIG. 8B shows a module 851 having two light emitting elements 855a and 855b. In this implementation, light emitting element 855a is disposed on connector 871a and light emitting element 875b is disposed on connector 871b. Other implementations of light emitting apparatuses may have 3, 4, 5, or more light emitting elements. The arrangement of the light emitting elements may vary depending on the special effects or visual display desired.

The modules described above have been shown to include an optical material, a light emitting element, a PCB, and connectors. This is not intended to limit the components within the module. The module may include additional features. For example, the light emitting apparatus may also include sensors disposed within the modules and electrically connected to the PCBs. The sensors may include image sensors (e.g., charge-coupled devices (CCD) or complementary metal-oxide-semiconductor (CMOS) sensors), infrared sensors, sound sensors (e.g., microphone), in addition to any other sensors. The sensors may, for example, enable the light emitting apparatus to detect multiple working conditions of the apparatus and assist in determining if the light emitting apparatus is fully functional. Further, the sensors, may enable the light emitting apparatus to detect multiple environmental conditions outside of the light emitting apparatus to determine, for example, if spectators are nearby or if other surrounding displays and apparatuses are in use. With detection of environmental conditions, the sensors may enable the light emitting apparatus to interact with its environment, such as illuminating in the presence of spectators.

With the inclusion of sensors within the light emitting apparatus, it may be beneficial to include a lens, prism, or any other optical device within the modules to assist in directing light within the modules. For example, if both a sensor and a light emitting element are included within a module, the light emitting element and the sensor may be positioned such that these components are not be located within the center of the module. In such an embodiment, the light emitted from the light emitting element may illuminate one side of the module more than another side of the module. To prevent such a problem, an optical device may be included within the module of the light emitting apparatus to recreate a uniform distribution of light within the module.

Furthermore, in the embodiments disclosed herein, the light emitting apparatus may include photovoltaic components electrically connected to the PCBs. Generally, photovoltaic components convert energy from photons within light into electrical energy. With photovoltaic components, light (e.g., sunlight) may be converted into electrical energy to supplement at least a portion, if not all, of the power used by the light emitting apparatus.

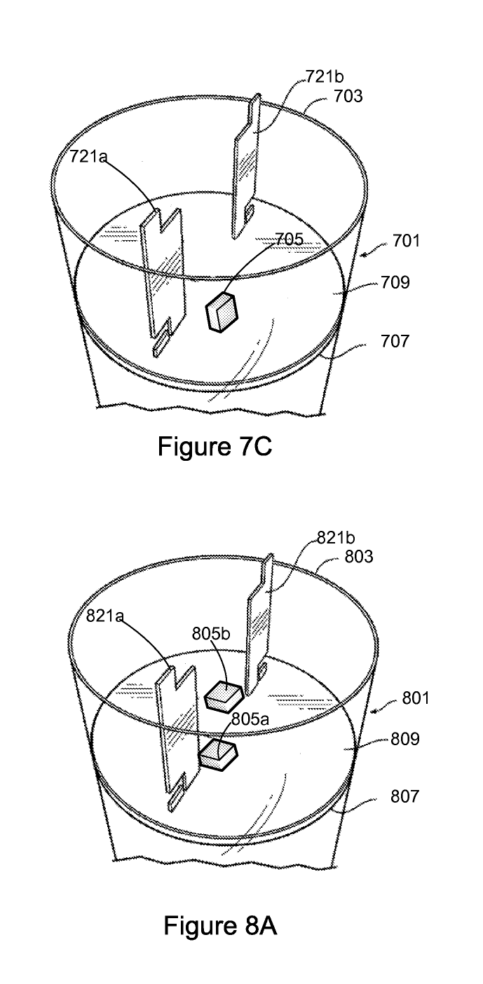

In another embodiment, the light emitting apparatus may also include an audio output element or device. The audio output element or device may be a speaker. FIG. 9 shows a perspective view of a module 901 of a light emitting apparatus with an audio output device. The module includes an audio output device 902, a light emitting element 905, a PCB 907 with planar surfaces 909 (e.g., planar surfaces 909 may include a top surface and a bottom surface of PCB 907), and connectors 921. Each PCB in the column may have an audio output element. Each audio output may be the same as others in the column. However, the audio output may be different from each other in terms of the frequency range an element is tuned for. For example, an audio output element (or speaker) may be a tweeter that is tuned to output higher frequencies. An audio output element may be a woofer that is tuned to output lower frequencies. Typically, the tweeters are arranged to be physically higher in the column (with respect to how the column is installed for use; e.g. tweeters will be positioned closer to ear level of person standing or sitting), while the woofers are arranged to be physically lower in the column (e.g., woofers positioned closer to waist level or below).

With such an array of audio output elements, the light emitting apparatus is also an audio output apparatus or device. Each audio output element may be a tweeter, woofer, horn, speaker, buzzer, or piezoelectric element, or other audio frequency output device, or any combination of these. The combination light and audio emitting apparatus can emit both light and sound, typically uniformly, to produce effects useful for dancing clubs, concerts, and other entertainment events and venues.

The audio output element is positioned on or disposed on a PCB. The audio output element may be electrically connected or coupled (e.g., connected to electrical traces) to the PCB. The audio output device may take electronic signals from an input source (e.g., a PCB 907) and turn the signals into sound. The audio output devices may output sound in association with the light emitting element. For example, the light emitting element may slowly change colors while the audio output device outputs slow music. Likewise, the light emitting element may quickly change colors while the audio output device outputs fast music.

In FIG. 9, the audio output device is disposed on top of the light emitting element. In this implementation, the audio output device is typically at a location on top of the light emitting element such that a minimum amount of light emitting from the light emitting element will be impeded (e.g., blocked) by the audio output device. In other implementations, however, the audio output device can be positioned at a different location in the module relative to the light emitting element and can be in close proximity to the light emitting element.

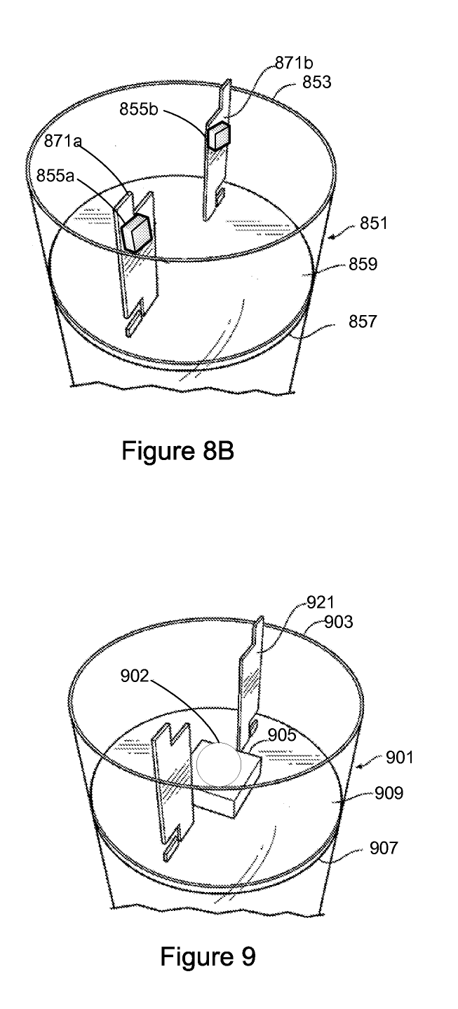

For example, FIG. 10 shows a top view of an audio output device 1002 mounted on a top planar surface of a PCB 1007, and disposed on a left side of a light emitting element 1005. The audio output device can also be disposed on a right side of the light emitting element, a left side of the light emitting element, a top side of the light emitting element, a bottom side of the light emitting element, or diagonally positioned on a side of the light emitting element (not shown).

In other implementations, the audio output device may not be in close proximity to the light emitting element. FIG. 11 shows a top view of an audio output device 1102 disposed on a PCB 1107 and positioned at a distance 1110 from a light emitting element 1105. The audio output device is at one end of the PCB and the light emitting element is at the other end.

FIG. 12 shows a side view of an audio output device 1202 disposed on a bottom planar surface of PCB 1207 and a light emitting element 1205 disposed on a top planar surface of PCB 1207. The audio output device and light emitting element are disposed on opposite planar surfaces of the PCB. FIG. 13 shows a side view of an audio output device 1302 disposed on an outside rim or edge of a PCB 1307.

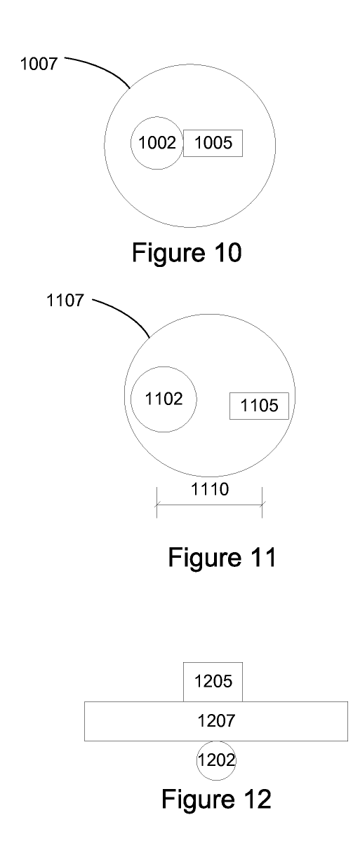

FIG. 9 shows the audio output device disposed on the light emitting element and FIG. 10-13 show the audio output device disposed on the PCB. This is not intended to limit the invention. The audio output device can be positioned or attached to other components of the module. For example, FIG. 14 shows an audio output device 1402 disposed on a connector 1421a. The audio output device is located a horizontal distance 1430 and a vertical distance 1434 from the light emitting element. The audio output device is not disposed on a PCB 1407 or attached to the PCB. This description is not intended to be exhaustive, and the audio output devices can also be positioned at other locations of the module.

FIGS. 9-14 show the modules having one audio output device. However, one having ordinary skill in the art will appreciate the invention is not so limited, and any number of audio output devices within the module may be used. For example, other implementations may have 0, 2, 3, 4, 5, or more audio output devices.

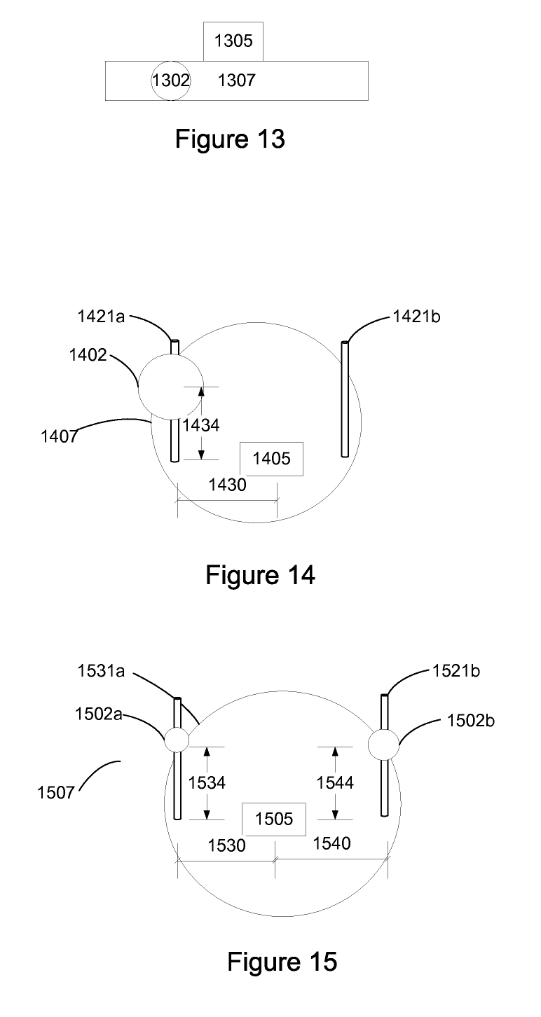

FIG. 15 shows a light emitting apparatus having two audio output devices. In the figure, an audio output device 1502a is disposed on a connector 1521a and an audio output device 1502b is disposed on a connector 1502b. Audio output device 1502a is located a horizontal distance 1530 and a vertical distance 1534 from the light emitting element. Audio output device 1502b is located a horizontal distance 1540 and a vertical distance 1544 from the light emitting element. These distances may vary. Audio output devices at opposite ends of a PCB 1507 may allow greater sound output and a better even distribution of sound in all directions. Further, audio output device 1502a and audio output device 1502b are different sizes. The number of audio output devices may vary depending on the sound requirements. The size of the audio output devices may also vary relative to one another.

The position of the audio output device on a side of the light emitting diode may obstruct the uniformity of the light. Further, unwanted shadows may appear. For example, referring back to FIG. 10, the light from light emitting diode 1005 may be obstructed due to the position of audio output device 1002 on its left side. Other implementations may position the audio output device relative to the light emitting element such that the module of the light emitting apparatus may appear uniform and without shadow problems.

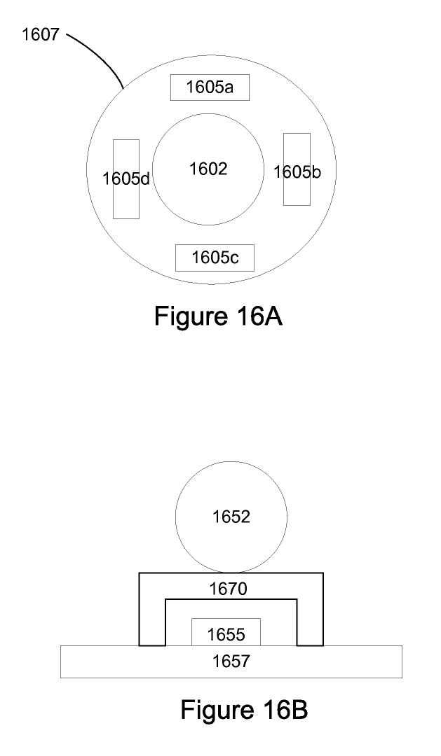

FIG. 16A shows an embodiment of an apparatus having four light emitting diodes 1605a, 1605b, 1605c, and 1605d and an audio output device 1602 disposed on a PCB 1607. Light emitting diode 1605a is on a first side of the audio output device, light emitting diode 1605b is on a second side of the audio output device, light emitting diode 1605c is on a third side of the audio output device, and light emitting diode 1605d is on a fourth side of the audio output device. In this arrangement, the audio output device would not cast a shadow on the output from the light emitting diodes.

FIG. 16B shows an embodiment of an apparatus having a light emitting diode 1655 disposed on a PCB 1657. An audio output device 1652 is arranged above the light emitting element or light emitting diode and is disposed on a support 1670. The support allows the audio output device to rest comfortably above the light emitting element without being in physical contact with the light emitting element. In another implementation, the support is in physical contact with the light emitting element.

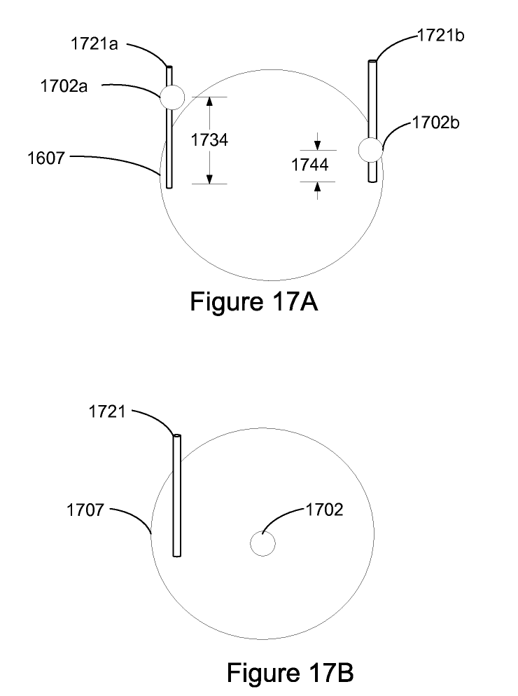

Further, although the light emitting apparatus has been described as including an audio output device and a light emitting element, the light emitting apparatus is not to be so limited. For example, the light emitting apparatus may include the audio output device with or without the light emitting element. FIG. 17A shows an embodiment of an apparatus having an audio output device 1702a disposed on a connector 1721a and an audio output device 1702b disposed on a connector 1702b. In the figure, the audio output devices are at different vertical lengths from the PCB. In particular, audio output device 1702a is a distance 1734 for the PCB, and audio output device 1702b is a distance 1744 from the PCB. Distance 1734 is greater than distance 1744. FIG. 17B shows another embodiment of an apparatus having an audio output device 1702 and a connector 1721. Audio output device 702 is disposed on the PCB. Further, in FIGS. 9-17, the audio output device is shown as having a circular shape. However, in other implementations, the audio output device can be a shape other a circular shape. For example, in other implementations, the audio output device can have a shape of a square, rectangle, triangle, sphere, or other shape.

With the inclusion of audio output devices within the light emitting apparatus, it may be beneficial to include a lens, prism, or any other optical device within the modules to assist in directing light within the modules. For example, if both an audio output device and a light emitting element are included within a module, light emitting element and the audio output device may be located such that neither is within the center of the module. In such an embodiment, the light emitted from the light emitting element may illuminate one side of the module more than another side of the module. To prevent such a problem, an optical device may be included within the module of the light emitting apparatus to recreate a uniform distribution of light within the module.

Those having ordinary skill in the art will appreciate that although the modules of the present invention are shown such that each module may have two adjacent modules connected (generally an adjacent module connected above and an adjacent module connected below), the invention is not so limited. In other embodiments, a module may have more than two adjacent modules connected thereto. For example, a module of a light emitting element may have a general Y-shape to connect to three adjacent modules, or may have a general T-shape to connect to four adjacent modules. Thus, light emitting apparatuses of the present invention may have multiple branches originating from modules configured to connect to more than two adjacent modules.

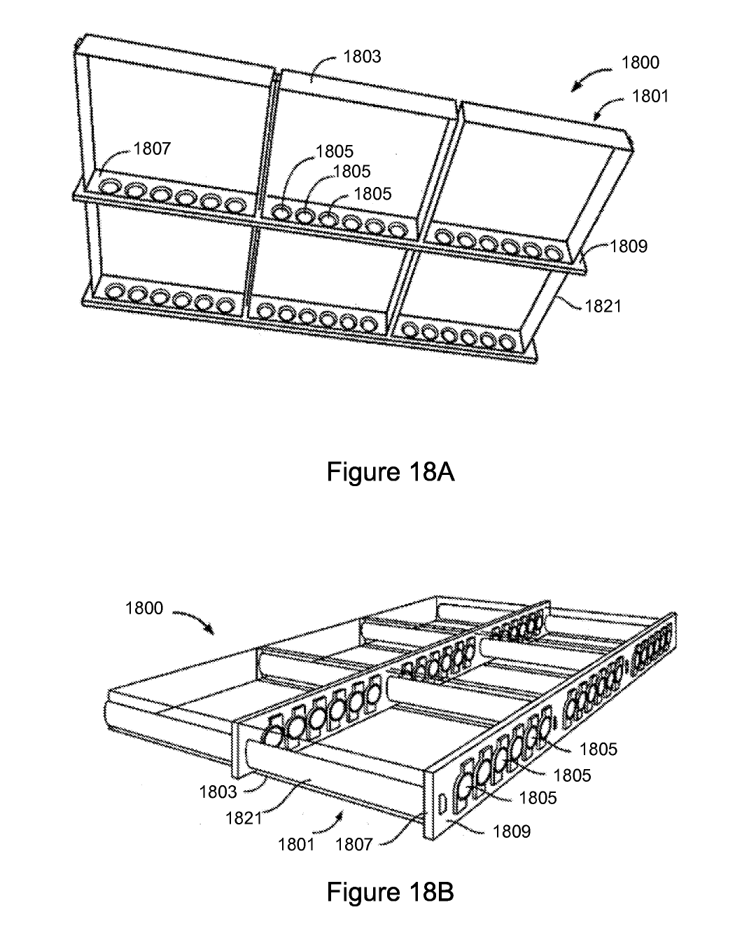

Additionally, as shown above, the PCBs and the light emitting apparatus of the present invention include a generally circular cross section. However, those having ordinary skill in the art will appreciate that the invention is not so limited. In other embodiments, the cross section of the PCBs or the light emitting apparatus, or both, may be square, triangular, oval, in addition to many other polygonal shapes. For example, FIGS. 18A and 18B show a light emitting apparatus 1800 in accordance with embodiments disclosed herein. PCBs 1807 of light emitting apparatus 1800 are of a polygonal (e.g., rectangular) shape, with multiple light emitting elements 1805 disposed upon and electrically connected to each PCB 1807. An optical material 1803 encompasses the multiple light emitting elements 1805 and may allow light to emit through optical material 1803.

Further, the PCBs have been shown to have a circular shape. However, those having ordinary skill in the art will appreciate that the invention is not so limited. For example, in other embodiments, the shape of the PCBs may be an oval, square, or rectangle. A PCB can have multiple edges, depending on its shape. For example, a PCB having a rectangular shape may have twelve edges, and also has six faces and eight vertices.

Further, as described above, the embodiments of the light emitting apparatus have power sent to the PCBs from an outside source. However, those having ordinary skill in the art will appreciate that the invention is not so limited. In other embodiments, an electrical energy storage device may be incorporated into the light emitting apparatus such that an outside power supply is not needed. For example, a battery may be disposed on or within an end of the light emitting apparatus for power supply. The apparatus can have a disposable or rechargeable battery that serves as a power source for the apparatus. When the battery or batteries are rechargeable, the apparatus can be plugged in to an AC power outlet and the battery can be recharged. The apparatus can be used portably many times without needing to replace the batteries. When the battery or batteries are disposable, the batteries can be replaced with fresh batteries when the existing battery is exhausted. The batteries can be located in the housing of the apparatus, such as at one end or both ends of a tube, or may be located on one or more PCBs. Alternatively, the batteries may be located remotely from the apparatus, and a set of batteries may be used to power multiple apparatuses.

Embodiments of the present invention may provide for one or more of the following advantages. In one embodiment, the present invention may provide for a light emitting apparatus that is viewable from a 360 degree angle surrounding the light emitting apparatus. In another embodiment, multiple light emitting apparatuses may be used and stacked in a system, such as an array. This system may be a two or three-dimensional array, in which two or three-dimensional video images may be created with the array of light emitting apparatuses. In another embodiment, the present invention may provide for a flexible light emitting apparatus. In such an embodiment, the bendable apparatus may or may not spring back into its original form after being bent.

Some modules have been described above as having an optical material that encompasses or encloses the PCBs and light emitting elements of the modules. However, the invention is not so limited. Instead of a rigid optical material used, an embodiment of the present invention may employ a gel or similar material to diffuse light. For example, in this implementation, an optically diffusing gel material encapsulates a first PCB with the light emitting element and a second PCB. The diffusing gel material can fill in gaps or spaces between the PCBs. In an implementation with diffusing gel material, the diffusing gel serves to diffuse the light from the light emitting elements, and also provides support for the structure, so rigid support structure may no longer be used. The diffusing gel material may be a polymer or silicone material that is flexible. A tube manufactured using the diffusing gel material may be referred to as a “slinky” tube because such a tube may be flexibly bent, without breaking, and return to its original shape.

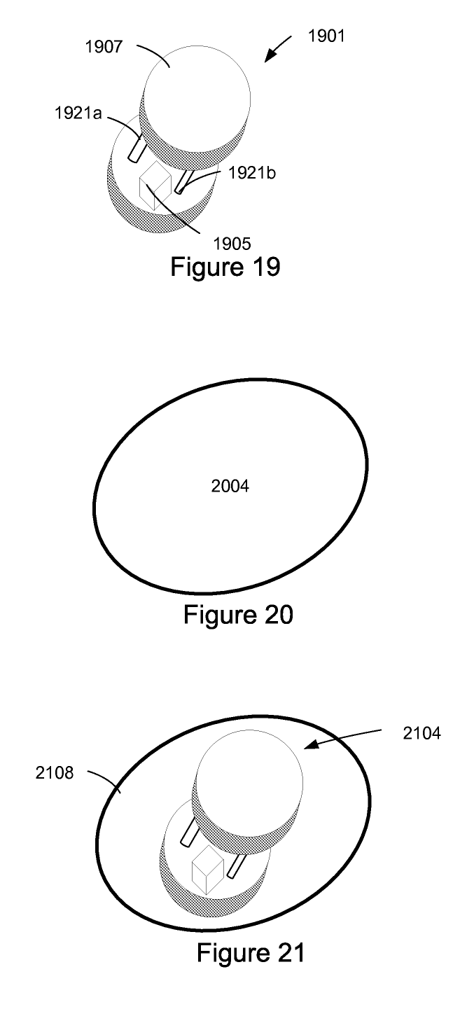

FIGS. 19-23 show steps in a process for using a mold and a gel material to diffuse light for a light emitting apparatus. A specific process flow for making the light emitting apparatus of the invention is presented below, but it should be understood that the invention is not limited to the specific flows and steps presented. A flow of the invention may have additional steps (not necessarily described in this application), different steps which replace some of the steps presented, fewer steps or a subset of the steps presented, or steps in a different order than presented, or any combination of these. Further, the steps in other implementations of the invention may not be exactly the same as the steps presented and may be modified or altered as appropriate for a particular application.

In an implementation for making the light emitting apparatus, the process includes:

1. Providing a module. FIG. 19 shows a module 1901 having a light emitting element 1905, a PCB 1907, and connectors 1921a and 1921b. The light emitting element and connectors are disposed on a surface of the PCB. There are gaps or spaces between the light emitting element and connectors.

2. Providing a mold to shape the light emitting apparatus. FIG. 20 shows a mold 2004 having a circular shape. The mold is large enough such that the module can fit in the mold.

The mold is shown as having a circular shape. However, other shapes are also possible. For example, the mold can have a star shape, triangular shape, rectangular shape, trapezoidal shape, amongst others. The mold will have the patterning or shapes that the manufacturer desires the light emitting apparatus to have.

3. Inserting or placing the module into the mold. FIG. 21 shows a module 2104 inside a mold 2108. There are spaces or gaps between the module and the mold.

4. Filling the mold with a diffusion material. The diffusion material can be squeezed or inserted into the mold. FIG. 22 shows a module 2204 inside a mold 2208 of a light emitting apparatus. A diffusion material 2212 fills a gap or a space inside the mold between the first and second PCBs. The diffusion material also diffuses light emitted from the module. In an implementation, the diffusion material substantially fills the space or gaps within the mold such that the sides of the mold are in contact with the diffusion material. In another implementation, the diffusion material fills up a percentage of the mold such that not all sides of the mold come into contact with the diffusion material.

The diffusion material can be inserted into the mold using a variety of techniques. In a specific implementation, the squeezing of the diffusion material into the mold is done by hand. However, in other implementations, the diffusion material is inserted into the mold mechanically or using a machine (e.g., computer-controlled injection). The mold may contain a small opening in which a device that holds the diffusion material can use to fill the mold with the diffusion material. Also, a needle or other sharp instrument may be used to pierce the mold and insert the diffusion material.

The diffusion material is of a material that allows light to pass through so that light will be visible from the outside. The material of the diffusion material can vary depending on the brightness or intensity of the light emitting element.

FIG. 23 shows a view of a module inside a mold 2308 with a diffusion material 2312. The module is inside the mold. A user may not be able to see a clear view of some features of the module (e.g., connectors and PCB) because the diffusion material blocks a clear view of the features. When the module lights up, light from an outside of the mold is visible to a user through the mold and diffusion material. Specifically, when the module lights up, a user can see light through the mold and diffusion material. In an implementation, the light transmitted appears to be uniform and lights up the surfaces of the mold evenly. When the module is not lighted up, the user may not realize that the light emitting apparatus is there.

5. Removing the mold. The mold can be used to shape the light emitting apparatus and is removed after a predetermined time period or a first time period. In an implementation, the first time period is when the diffusion material has set into a form capable of supporting itself without the mold. FIG. 24 shows a view of a module with a diffusion material 2412. A user may not be able to see a clear view of some features of the module (e.g., connectors and PCB) because the diffusion material blocks a clear view of the features. When the module lights up, light from an outside of the light emitting apparatus is visible to a user through the diffusion material. Specifically, when the module lights up, a user can see light through the diffusion material. The diffusing material spreads or diffuses the light generally uniformly. With the module is not lighted up, the user may not even realize that the lighting emitting apparatus is there.

The shapes of the mold were described as having a circular shape or elliptical shape. The light emitting apparatus, however, can be molded into different shapes. In an implementation, the light emitting apparatus has a shape of a slinky tube, rectangle, square, trapezoid, or pentagon. Further, the cross sections of the optically diffusing gel material may also vary. For example, the cross sections of the optically diffusing gel material may have a circular, oval, rectangular, square, or triangular cross section, in addition to other polygonal cross sections.

Alternatively, the mold may not be removed from the light emitting apparatus. The mold may be transparent or substantially transparent such that after the gel has set and the light emitting apparatus emits light, light is visible to a user from an outside of the mold.

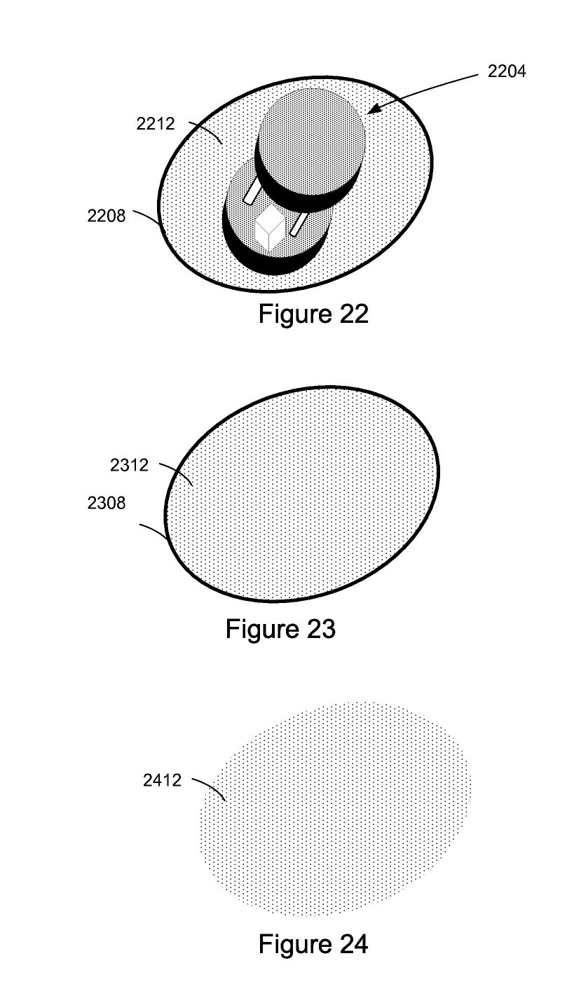

FIG. 25 shows another specific implementation of a light emitting apparatus. The light emitting apparatus has modules 2501 having light emitting elements 2505 and PCBs 2507. The light emitting apparatus is substantially enclosed by a mold 2508. After the gel material has set, the apparatus can be removed from the mold and the gel material is a solid at room temperature. The gel material may be a liquid at room or other temperature until it is subjected to certain conditions, such as a catalyst material, specific temperature, pressure, or other factors. However, in the final product, the gel material is a semisolid material that has flexible characteristic, so that the apparatus may be flexed and changed into a different orientation without breaking.

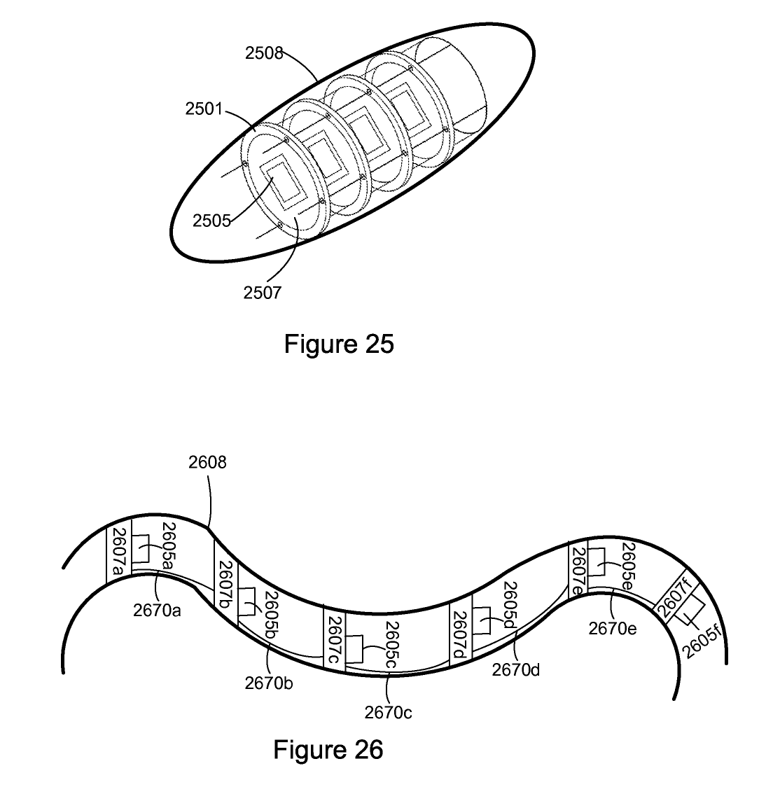

FIG. 26 shows a light emitting apparatus having a light emitting element 2605a disposed on a PCB 2607a, a light emitting element 2605b disposed on a PCB 2607b, and so on. A connector 2670a connects PCB 2607a to PCB 2607b, a connector 2670b connects PCB 2607b to PCB 2607c, and so on. The connector can be a wire that electrically connects PCBs together, and is flexible. FIG. 26 shows that the apparatus is in a flexed (e.g., bended) position that is different from an initial state or rest state of the apparatus. For example, this initial state may be a long straight, linear tube. In FIG. 26, the apparatus is flexed to have multiple bends and turns (e.g., up, down, left, right, U turn, L turn, 90 degree turn, 120 degree turn, and other turns). For example, at position 2608 there is a bend. In an implementation, the apparatus can be bent as shown in FIG. 26 and then returned to its initial shape (e.g., straight tube). The initial shape need not be a straight tube, but can be molded to become other initial shapes. Some other initial shapes can include U shape, circle or circular shape, L shape, and others.

The optical diffuser material can include different materials and based on the material, may or may not conduct electricity. The optical diffuser material can be made of a substantially flexible material. In an implementation, the diffusion material is a gel of some sort such as silicone or silica gel. The elasticity of some polymers is affected by temperature. In an implementation, the optical diffuser material includes a flexible polymer. In this implementation, the module can be substantially flexible and not rigid. A connector that connects a first PCB to a second PCB can be rigid or flexible. In FIG. 26, connectors or wires 2670a, 2670b, 2670c, and 2670d are capable of bending with the shape of the module. In this implementation, a user can bend the lighting module as desired. For example, when a user bends or applies force to the light emitting apparatus shown in FIG. 26 at position 2608, connector 2670a also bends according to the force applied by the user. A user can bend the light emitting apparatus to a desired shape. When the user releases the hold or stops applying pressure at position 2608, the light emitting apparatus may continue to stay at that different orientation or revert back to its initial shape.

In another implementation, the optical diffuser material includes a rigid polymer. In this implementation, the module is substantially rigid and may not be capable of bending when a user puts pressure on the module.

The optical diffuser material may include materials such as silicon dioxide. Native silicone dioxide is a high quality electrical insulator. Other materials can also be used including a polymer, quartz, borosilicate glass, plastic, polyurethane, polycarbonate, and others. The diffusing properties of the material can be by coloring or clouding the material to give an appropriate or desired diffusing effect (e.g., uniform diffusing, sunburst or startburst diffusing, and others). The diffusing property may also be achieved by faceting, surface treatment (such as etching or printing), and others.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A device comprising:
a first printed circuit board, wherein the first printed circuit board has a first edge;
a second printed circuit board;
at least a first connector, coupling to and extending between the first and second printed circuit boards; and
a light emitting element positioned on the first printed circuit board and electrically coupled to the first printed circuit board,
wherein a shortest distance between the first connector to the first edge is less than a shortest distance between the light emitting element to the edge.

2. The device of claim 1 wherein the first and second printed circuit boards are arranged in a column, the second printed circuit board is above the light emitting element and the first printed circuit board, and the first connector extends transverse to surfaces of the first and second printed circuit boards.

3. The device of claim 1 comprising:
a wire, extending between the first and second printed circuit boards and coupling to electrical traces of the first and second printed circuit boards.

4. The device of claim 1 comprising:
a wire, coupling to electrical traces of the first and second printed circuit boards and routed between the first and second printed circuit boards adjacent to the first connector.

5. The device of claim 1 wherein the first connector comprises an electrically conductive portion that facilitates an electrical connection between electrical traces of the first and second printed circuit boards.

6. The device of claim 1 wherein the first connector comprises at least a rigid nonelectrically conductive portion that does not pass electricity between the first and second printed circuit boards.

7. The device of claim 1 comprising:
an audio output element positioned on the first printed circuit board and electrically coupled to the first printed circuit board.

8. The device of claim 1 comprising:
an optical diffuser material substantially encompassing the first printed circuit board with the light emitting element and second printed circuit board.

9. The device of claim 8 wherein the optical diffuser material has a circular cross section.

10. The device of claim 8 wherein the optical diffuser material has a polygonal cross section.

11. The device of claim 8 wherein the optical diffuser material has an oval cross section.

12. The device of claim 8 wherein the optical diffuser material has a rectangular cross section.

13. The device of claim 1 comprising:
an optically diffusing gel material encapsulating the first printed circuit board with the light emitting element and second printed circuit board, wherein the at least a first connector is flexible.

14. The device of claim 13 wherein optically diffusing gel material has a circular cross section.

15. The device of claim 13 wherein the optically diffusing gel material has a polygonal cross section.

16. The device of claim 13 wherein the optically diffusing gel material has an oval cross section.

17. The device of claim 13 wherein the optically diffusing gel material has a rectangular cross section.

18. The device of claim 13 wherein the optically diffusing gel material comprises a flexible polymer.

19. The device of claim 13 wherein the first connector is a wire.

20. The device of claim 13 wherein the optically diffusing gel material fills a space between the first and second printed circuit boards.

21. The device of claim 8 wherein the optical diffuser material comprises a rigid polymer.

22. The device of claim 8 wherein the optical diffuser material comprises a flexible polymer.

23. The device of claim 8 wherein the optical diffuser material comprises silicon dioxide.

24. The device of claim 1 wherein the light emitting element comprises a first light emitting diode emitting light of a first color and a second light emitting diode emitting light of a second color.

25. A device comprising:
a first printed circuit board, wherein the first printed circuit board has a first edge;
a second printed circuit board;
at least a first connector, coupling to and extending between the first and second printed circuit boards; and
a first light emitting element coupled to and positioned on the first connector, wherein the first and second printed circuit board are arranged in a column, and the light emitting element is between the first and second printed circuit boards.

26. The device of claim 25 comprising:
a second light emitting element positioned on the first printed circuit board and electrically coupled to the first printed circuit board,
wherein a shortest distance between the first connector to the first edge is less than a shortest distance between the first light emitting element to the edge.

27. The device of claim 25 comprising:
an audio output element positioned on the first printed circuit board and electrically coupled to the first printed circuit board.

28. A method of making a light emitting apparatus comprising:
providing a first module, the first module comprising a first light emitting element, a first PCB, and at least a first connector;
providing a mold to shape the light emitting apparatus;
inserting the first module into the mold; and
after inserting the first module into the mold, inserting a diffusion material into the mold, the diffusion material being arranged to come into contact with the first module.

29. The method of claim 28 comprising:
removing the mold after a first time period.

30. The method of claim 28 wherein the diffusion material comprises a silicone material.

31. The method of claim 28 wherein the diffusion material substantially fills the mold.

32. The method of claim 28 further comprising:
providing a second module, the second module comprising a second light emitting element, a second PCB, and at least a second connector;
inserting the second module into the mold; and
after inserting the second module into the mold, inserting a diffusion material into the mold, the diffusion material being arranged to come into contact with the second module.
